(19) United States
(12) Patent Application Publication
(10) Pub. No.: US 2007/0240469 A1
(43) Pub. Date: Oct. 18, 2007

(54) Method and apparatus for treating pig manure

(76) Inventors: Luc Lachapelle, Montreal (CA); Jean-Luc Goyer, St-Ours (CA)

Correspondence Address: Eric Fincham, 316 Knowlton Road, Lac Brome, QC, J0E 1V0, CA

(21) Appl. No.: 11/708,250

(22) Filed: Feb. 20, 2007

Related U.S. Application Data
(63) Continuation-in-part of application No. 10/808,983, filed on Mar. 24, 2004, now abandoned.

(51) Int. Cl. C05F 3/00

(52) U.S. Cl. 71/21

(57) ABSTRACT

A method for the treatment of phosphorus containing waste waters, particularly pig manure, which comprises separating the waste water into a solids faction and a liquid faction, mixing the liquid faction with a mineral substance to reduce the phosphor content, and separating the liquid faction from the mineral substance. A preferred mineral substance is quarry fines.

### FIELD OF INVENTION

This application is a Continuation-in-Part of application Ser. No. 10/808,983 filed Mar. 24, 2004.

The present invention relates to a method and apparatus for the treatment of liquid manure. More particularly the invention provides an economical, efficient and environmentally friendly method and the equipment for treatment of the liquid faction of manure, or any particular phosphor containing waste water that may need that kind of treatment, in order to balance its main fertilizing elements, mainly nitrogen and phosphor so that it can be used productively as a fertilizer or other use. The resulting balanced manure or treated water will correspond to the needs of the plants and the phosphor saturation level of the soil where it will be spread. The described method and equipment described further can apply to manure or other phosphor containing waste waters.

### BACKGROUND OF THE INVENTION

Pig production constitutes an important agricultural and economical activity. However this production, particularly managing manure has generated some environmental problems affecting water resources. Spreading untreated manure on agricultural lands for fertilization is a common practice. However, these lands quickly become saturated with phosphor and the excess phosphor flows towards surrounding waterways. Usually, the farm doesn't have sufficient surfaces for the animal wastes that it produces; also the totality of local agricultural lands are not sufficient to receive all the animal wastes on a given territory. Consequently, the phosphor needs of the land are usually exceeded.

The composition of manure, including phosphor and nitrogen is a function of phosphor in the liquid manure is usually in the form of phytate, which is the salt of phytinic acid, dihydrogen phosphate, and consists of a sugar molecule with six phosphate molecules. Single stomach animals such as pigs are not capable of absorbing sufficient phosphate from their feed and accordingly, a large part of it finds its way, substantially undigested, into the manure of the animal. The pigs need phosphor for a good bone structure and since they are unable to absorb sufficient phosphate from their feed, extra phosphor is often added to the feed. In pig farming, the animals are kept in one of three different areas according to its maturity stage: the first area is the maternity area, a second area where they stay in a nursery type of arrangement, and a final area where the pigs are fattened for slaughter. Each of the pig manures coming from the three areas has somewhat different properties.

Several technologies have already been proposed or are under investigation to solve this problem of excess phosphor in pig manure and in culture fields. Some of these technologies requires investment on the part of the pig producer, if he wants to do the treatment himself. Other methods involve the costly transportation of manure for treatment in a special plant or facility or involve the use of chemical products including “polymers” which the farmers want to avoid because of the unknown long term effects on soils, plants, animals and humans.

The object of this invention is to propose a simple, economical and fast method to treat liquid manure and other waste liquid in order to balance its fertilizers content corresponding to the needs and, to the phosphor saturation level where it will be spread. This method takes into account the following attributes.
Productive usage of elements from the environment (manure and mineral components);
Preservation of the environment
Proper use of agricultural land
Limit the transport of waste liquids
Absence of polymenic material and other non biodegradables
Provide a liquid which is ready to use as a fertilizer
Capable of being processed on site
Provide fast processing

### SUMMARY OF THE INVENTION

It is an object of the invention to provide a method and equipment for the treatment of a liquid such as liquid manure.

It is a further object of the present invention to provide a method and apparatus for the treatment of liquid manure wherein quarry fines are used for reducing the phosphor content of the liquid phase, and producing manure more balanced with regards to Nitrogen phosphor for fertilization of soils with a high content in phosphor.

It is a further object of the present invention to provide mobile equipment for the treatment of liquid manure comprising a first system that mixes the liquid faction with an adequate quantity of quarry fines, a second system that blends the mixture in a way to favor the fixation reaction between the mineral components and the liquid phosphor and a third system that separates the liquid from the mineral components and other solids.

According to one aspect of the present invention, there is provided a method for the use of quarry fines comprising the steps of allowing the pig manure to decant in a tank, separating the pig manure into a solids portion and a liquid portion, mixing the liquid portion with the quarry fines for a period of time sufficient to reduce the phosphor content thereof, and separating the liquid portion from the quarry fines to provide a liquid suitable for use as a fertilizer.

The method of the present invention is carried out such that the liquid portion is mixed with the quarry fines without any pre-treatment. Preferably, the quarry fines in liquid are mixed for at least 30 minutes. In a preferred embodiment, the nitrogen and phosphorous content of the pig manure is measured prior to separating the waste water into a solid portion and a liquid portion.

Referring initially to FIG. 1, providing graphs showing the concentration of various components of the liquid pig manure, the control was done without mechanical separation of the liquid faction; however, mechanical separation was done before treatment for products P1, P2, P3 and P4. In this regard, trial P1 utilized quarry fines from a pig having a substantial portion of limestone; P2 were fines from a different quarry;

P3 were from a quarry having a shale type structure and P4 was slag from a metal processing operation.

In greater detail, in a first step, manure with a minimal solid faction proportion should be attained since there is a desirable level. If the solid matter, that is the organic form., is higher than this desirable level, then the manure is desirably processed by a mechanical separator to remove as much solid matter as possible from the original manure to attain a proportion close to this desirable value. There are several commercial known separators that could do the work. However it has been found that the method is most efficient only upon attainment of the right percentage (or lower) of solid matter. Once this prerequisite is attained, then, measures of the nitrogen and phosphorus content, and, possibly other measures, are taken from the liquid manure and from the soil on which the fertilizers would be used after the process.

Pig manure decants naturally in a tank. Accordingly, approximatively ¾ of the volume of manure in a tank is a liquid phase of the manure that can be recuperated with a pump. This liquid is rich in ammonium and potassium but is normally weak in phosphor content. If the nitrogen/phosphorus ratio is adequate, large quantities of this liquid manure can be applied to the lands to provide fertilization. If the dosage, such as an excess of phosphorus is not adequate, then a treatment is advised before spreading.

On the other hand, the bottom of the manure tank , contains one quarter of the gross pig manure which normally has a rich mineral, organic and phosphor content. The proportion of solids normally ranges from 8 to 12%. Treating this substance through a mechanical separator will produce a liquid high in phosphor content. The nitrogen and phosphorus concentrations of that liquid might not be adequate to fertilize fields already rich in phosphorus content. The agronomic needs of the fields are ideally included within a range of value of N/P₂O₅ from 5 to 7. Once nitrogen and phosphorus concentrations are determined and the value nitrogen/phosphorus calculated, it is possible to consider a treatment with mineral components including quarry fines rich in calcium or iron or other known minerals to attain the desired N/P₂O₅ value.

In the presence of high solid contents, quarry fines are somewhat less efficient to reduce the phosphor content in pig manure. The organic matter may block the action of the quarry fines on the phosphor. Therefore one should reduce the organic solid content to a very low proportion. There are several commercial equipments that can be used to reduce the organic solid content of a manure solution.

In a second step, once proper measures of the liquid manure are taken and once some clear objectives of the values of phosphor and nitrogen are determined, quarry material which comprises an adequate quantity of quarry fines are added and mixed with the liquid manure in a first operation. The period of time required for this operation can range from fifteen minutes upwardly.

Phosphor in the manure can be found either in mineral or organic form. The mineral form of phosphor, that is mainly composed of orthophosphates is very soluble. It also reacts strongly with minerals such as calcium and iron. The addition of natural products rich in content of these available minerals would reduce the phosphate content in the liquid phase of manure, increasing the phosphate content in the solid phase. Accordingly, it has been found that the quarry fines which have a very high surface area, remove a substantial portion of the phosphor from the liquid faction. An advantage of the present method is that the mineral components including quarry fines over a certain period of time appear to “fix” the phosphor. And accordingly, one is then provided with a liquid which is then suitable for use as a fertilizer.

In a third step, optimized conditions are maintained to trigger, propagate and accelerate the reaction within this mixture that will solidify some of the phosphor. This operation can take from 30 minutes to an hour depending on the type of mineral components used and on the degree of saturation of phosphor and /or organic matter. For a proper reaction to happen, the mixture must be maintained homogeneous to maximize even distribution of mineral components in the mixture, avoiding vigorous blending so the new bonds created between molecules are not broken. As such, a propeller at either the bottom, or top of the equipment, functioning at a moderate speed can ensure that the mineral components are distributed and not accumulated at the bottom of the container. Other devices could also be used.

In a fourth step, the solid components of the mixture are mechanically separated from the remaining balanced liquid manure. For example a worm screw could be used for this function, without excluding any other device. Accordingly, one is then provided with a liquid which is then suitable for use as a balanced fertilizer with the proper nitrogen/phosphorus value.

As aforementioned, there is also provided a mobile unit adapted to treat manure. In this method and as is conventional in pig farming, the manure would initially be restricted to a settling operation on the pig farm. Subsequently, the mobile equipment could include three sections to carry out sequential operation on the liquid manner. Thus the liquid manure is mixed with a predetermined amount of mineral components . The mixture is stirred and a reaction between these stone fines and liquid manure allowed to proceed. Subsequently, the solids some of which are rich in phosphor, are extracted.

The mixing of mineral components including quarry fines with the liquid manure will be carried out on the basis of a measurement of the properties of the liquid manner. Such techniques are well known in the art.

Subsequently, the mixture is directed to one or several cisterns and may be proportioned in such a manner that it standardizes a reaction between components.

The final section of the mobile unit would function to provide a separation of the liquid from the solids phase which consist primarily of the quarry fines and fixed phosphor.

### BRIEF DESCRIPTION OF DRAWINGS

Having thus generally described the invention, reference will be made to the accompanying tables and figures illustrating different aspects of the invention, wherein:

FIG. 1a is a graph providing the total nitrogen content when the liquid manure is treated with different materials;

FIG. 1b is a graph illustrating the phosphorus content thereof;

FIG. 1c is a graph illustrating the N/P₂ O₅ ratio thereof;

FIG. 1d is a graph illustrating the ammonium content thereof;

FIG. 2 is a graph illustrating the results of a treatment of the liquid manure with different components and shows the phosphorus content versus reaction time;

FIG. 3 shows the separation time of mineral components for different types of pig manure;

FIG. 4 is a schematic view of a method for the treatment of manure;

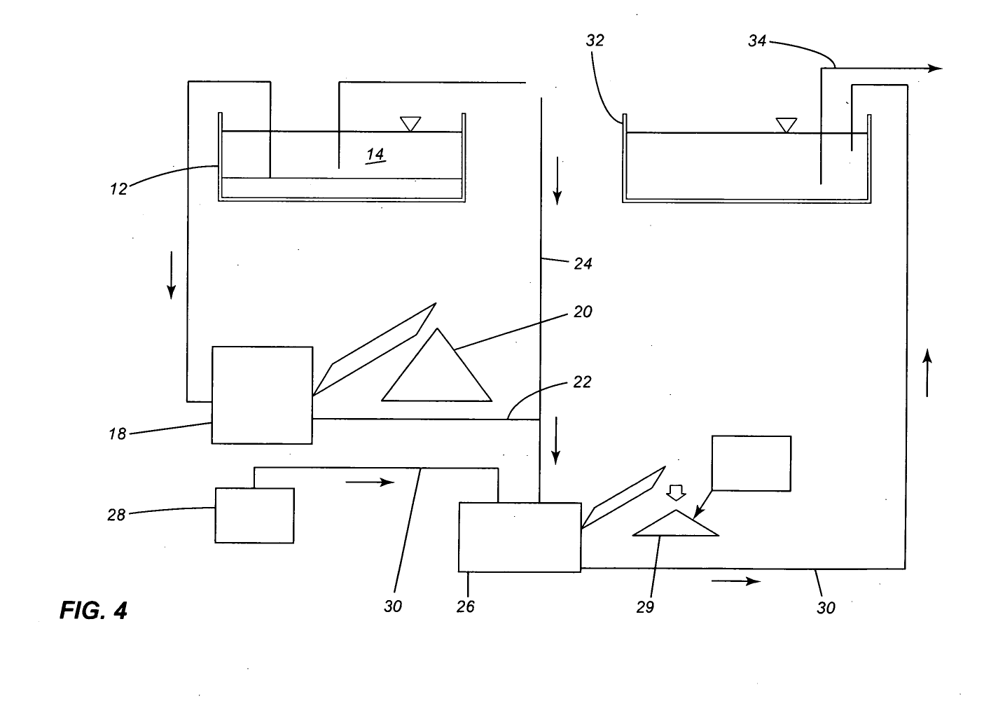

Turning initially to FIG. 4, there is illustrated an apparatus for carrying out the process of the present invention and which apparatus is schematically illustrated.

Thus, there is provided a first container 10 to receive the liquid manure. Therein, the liquid manure will separate into a solids faction 12 and a liquid faction 14. Liquid faction 14 is transferred through conduit 16 to a mechanical separator 18. The solids content is then transferred to a storage 20 where it can be used for many different purposes. The liquid portion is transferred through conduit 22.

From container 10, the liquid faction is transferred through conduit 24 which meets with conduit 22 and the liquid is transferred to a mixing container 26.

Quarry fines 28 are then transferred through line 30 to container 26 where the two are mixed and allowed to react. Subsequently, the mineral solids are transferred to storage 29 while the treated liquid, reduced in phosphor, is transferred by conduit 30 to a equilibrium container 32. Subsequently, the liquid may be transferred through conduit 34 for use as a fertilizer.

Naturally, it will be understood that suitable pumps and the like may be utilized for the transfer of the solids/liquids and it is within the skill of one knowledgeable in the art to do so.

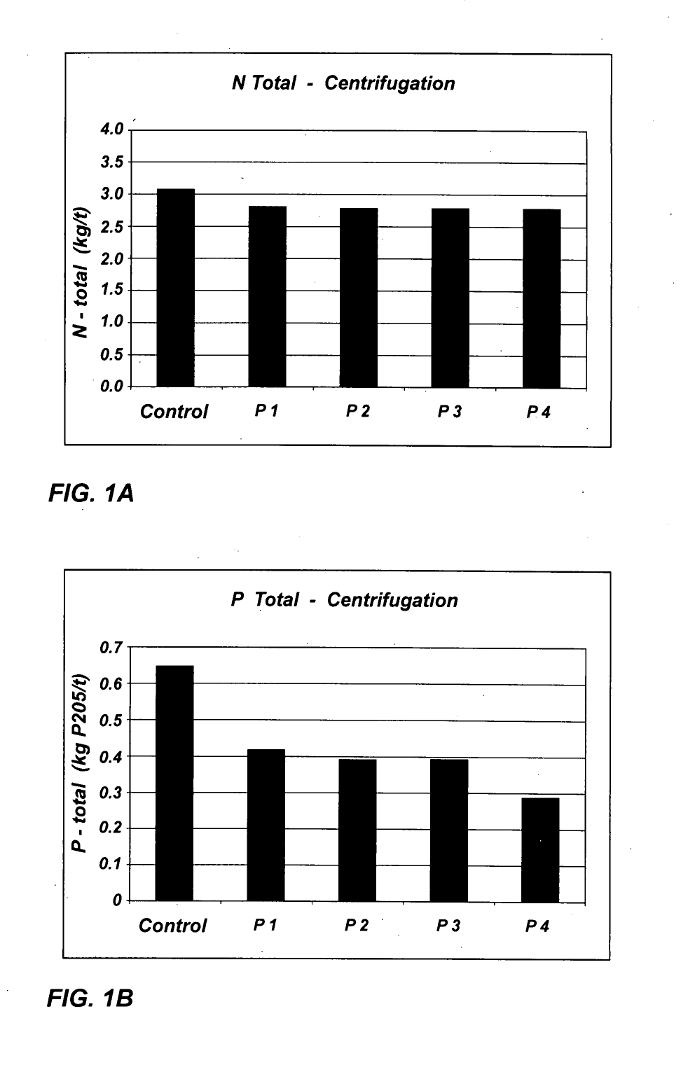

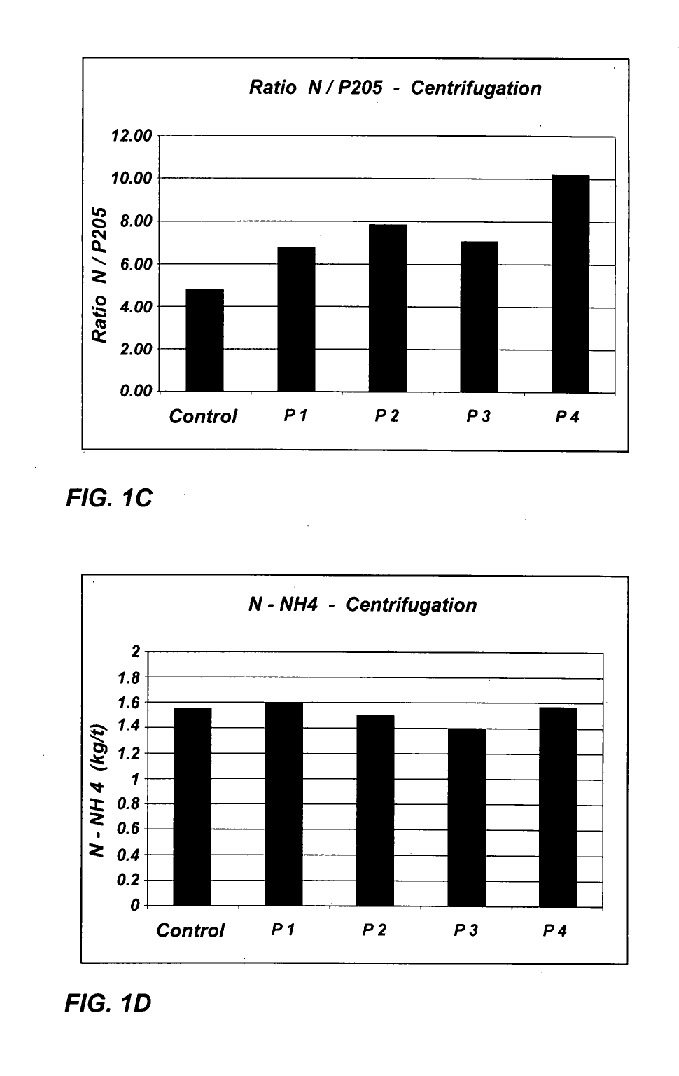

Various trials were run utilizing different types of material. The results are illustrated in FIG. 1A through 1D.

In this trial,

P1 indicated quarry fines which came from a limestone ridge quarry;

P2 came from a further quarry;

P3 came from a quarry which was rich in a shale type structure; and

P4 represented slags from a metal plant.

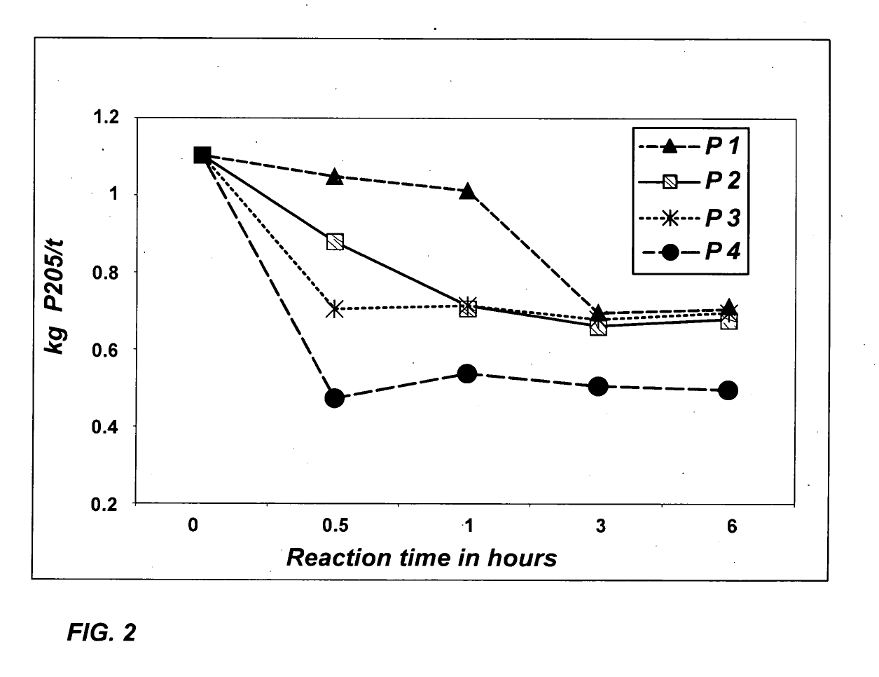

FIG. 2 is a graph of the NP₂O₅ versus the reaction time for the various types of mineral additives.

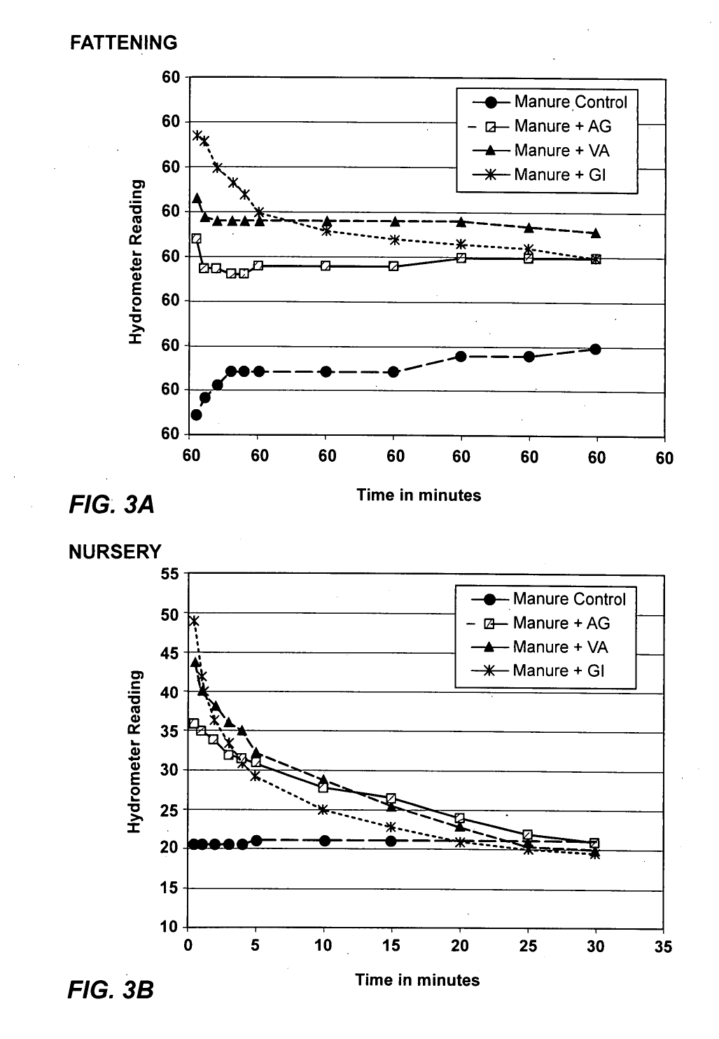

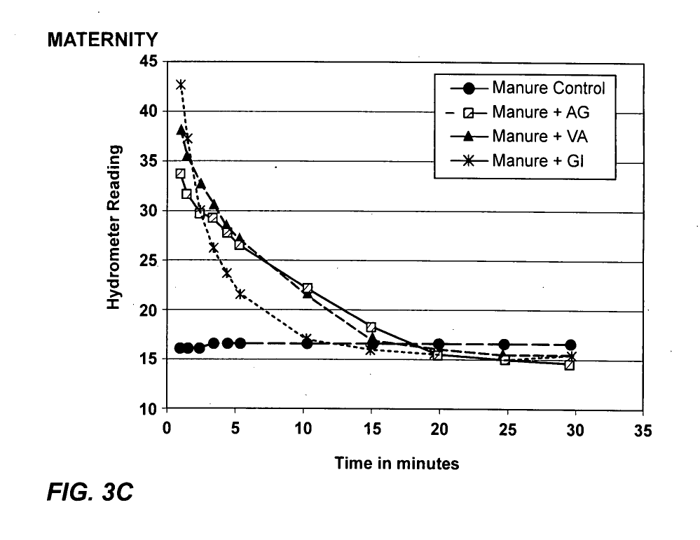

In FIG. 3, there is illustrated the sedimentation time for manure from different stages of the pig's development.

### EXAMPLE 2

A liquid manure of the pre pit was pumped and filtered through the separator. The solid portion was returned to the pit and the liquid portion was pumped and directed to a storage and stirring container. In this container, a pump was constantly stirring the liquid in order to obtain a homogenous liquid (constant phosphor). An exit and a plurality of gates located on the expulsion conduit of this pump allowed for a moderate and constant flow for the treatment. This moderate flow was 3.5 to 4.0 gal/min (15 to 181/min or 0.9 to 1.0 m. cu./hour) for all trials.

Flow: 1 m·cu/hour

TABLE I
Analysis of the non-treated pits

| Trial No. | Date | Pit | M.S. | M.O. | Nt | Pt | N/P | Sulfurs |
|---|---|---|---|---|---|---|---|---|
| Separation | 20-apr-06 | Crude | 14500 | 12400 | 0.0 | 639.0 | 0.0 | |
| | | Separated | 2400 | 16100 | 2510.0 | 878.0 | 2.9 | |
| | | Solids | 303000 | 273000 | 18400.0 | 8150.0 | 2.2 | |
| 1 | 21-apr-06 | 1 A 1 | 17000 | 10600 | 2310.0 | 500.0 | 4.6 | 24.80 |
| | 21-apr-06 | 1 A 2 | 17500 | 11000 | 2310.0 | 510.0 | 4.5 | |
| | | Aver. 1 | 17250 | 10800 | 2310 | 505 | 4.57 | 24.80 |
| 2 | 21-apr-06 | 2 A 1 | 29300 | 12200 | 2210.0 | 541.0 | 4.1 | 30.60 |
| | 21-apr-06 | 2 A 2 | 20100 | 12900 | 2450.0 | 587.0 | 4.2 | |
| | | Aver. 2 | 24700 | 12550 | 2330 | 564 | 4.13 | 30.60 |
| 3 | 21-apr-06 | 3 A 1 | 21500 | 14400 | 2160.0 | 709.0 | 3.0 | 32.20 |
| | 21-apr-06 | 3 A 2 | 22500 | 15100 | 2260.0 | 721.0 | 3.1 | |
| | | Aver. 3 | 22000 | 14750 | 2210 | 715 | 3.09 | 32.20 |

Flow: 1 m·cu/hour

TABLE II
Analysis of the treated pits

| | | | | | | | | | VARIATION (%) | | | | | |
|---|---|---|---|---|---|---|---|---|---|---|---|---|---|---|
| Trial No. | Date | Pit | M.S. | M.O. | Nt | Pt | N/P | Sulfurs | M.S. | M.O. | N | P | N/P | Sulfurs |
| 1 | Opening | Aver. 1 | 17250 | 10800 | 1155.0 | 505.0 | 2.3 | 24.80 | | | | | | |
| Exit | 21-apr-06 | 1 B 1 | 81800 | 11500 | 1620.0 | 330.0 | 4.9 | | 374 | 6 | 40 | −35 | 117 | |
| | 21-apr-06 | 1 C 1 | 11400 | 3730 | 837.0 | 125.0 | 6.7 | | −34 | −65 | −28 | −75 | 196 | |
| | 21-apr-06 | 1 C 2 | 12600 | 4170 | 903.0 | 132.0 | 6.8 | 8.05 | −27 | −61 | −22 | −74 | 202 | −68 |
| | 21-apr-06 | 1 C 3 | 28100 | 12600 | 599.0 | 89.0 | 6.7 | | 63 | 17 | −48 | −82 | 197 | |
| 2 | Opening | Aver. 2 | 24700 | 12550 | 2310.0 | 564.0 | 4.1 | 30.60 | | | | | | |
| Exit | 21-apr-06 | 2 B 1 | 84300 | 14300 | 2070.0 | 483.0 | 4.3 | | 241 | 14 | −10 | −14 | 4 | |
| | 21-apr-06 | 2 C 1 | 15800 | 7150 | 1870.0 | 182.0 | 10.3 | | −32 | −43 | −19 | −68 | 149 | |
| | 21-apr-06 | 2 C 2 | 14900 | 7110 | 1960.0 | 185.0 | 10.6 | 11.40 | −40 | −43 | −15 | −67 | 157 | −63 |
| | 21-apr-06 | 2 C 3 | 13900 | 6670 | 2120.0 | 172.0 | 12.3 | | −44 | −47 | −8 | −70 | 198 | |
| 3 | Opening | Aver. 3 | 22000 | 14750 | 2210.0 | 715.0 | 3.1 | 32.20 | | | | | | |
| Exit | 21-apr-06 | 3 B 1 | 58900 | 13800 | 1960.0 | 536.0 | 3.7 | | 168 | −6 | −11 | −25 | 18 | |
| | 21-apr-06 | 3 C 1 | 37900 | 11500 | 1920.0 | 381.0 | 5.0 | | 72 | −22 | −13 | −47 | 63 | |
| | 21-apr-06 | 3 C 2 | 13400 | 6800 | 2180.0 | 170.0 | 12.8 | 9.05 | −39 | −54 | −1 | −76 | 315 | −72 |
| | 21-apr-06 | 3 C 3 | 29000 | 9010 | 1950 | 327 | 6.0 | | 32 | −39 | −12 | −54 | 93 | |

In a general manner, the analysis of the samples have illustrated that there was an average reduction of 50% of the total phosphor between the liquid manure at the opening and the one coming out after treatment. This percentage increases at more than 70% when doubling the dosage of one of the mineral particles.

Between 10 to 50% of the total nitrogen is lost during the treatment. The trial model did not have a device to prevent this loss. This could be corrected by modifying the stirring containers and other constituents.

When comparing the results of average points B and C, the total dry material of the treated pig manure decreased during the experiment, due to the decanter which allowed for the removal of this material. The quantity of organic material also decreased in a higher proportion than for the total material, which leads one to believe that part of the organic material was caught by the quarry fines and decanted. This was one of the desired results of the experiment.

The N/P factor strongly increased during the experiment, from 60 to more than 300%. This was the main objective of the experiment.

The quantity of sulfurs decreased in a proportion of 60 to 70% during treatment. This reduction gives an indication of the loss of total sulfur in the form of H2S which is the main gas causing odors in the treated pig manure. The odor reduction between the incoming and the outgoing pig manure was also noted on the site during the experiment It will be understood that the above described embodiments are for purposes of illustration only and that changes and modifications may be made thereto without departing from the spirit and scope of the invention.

I claim:

1. A method for the use of quarry fines comprising the steps of:
allowing said pig manure to decant in a tank;
separating said pig manure into a solids portion and a liquid portion;
mixing said liquid portion with said quarry fines for a period of time sufficient to reduce the phosphor content thereof; and
separating said liquid portion from said quarry fines to provide a liquid suitable for use as a fertilizer.

2. The method of claim 1 where wherein said quarry fines and liquid portion are mixed for at least 30 minutes.

3. The method of claim 2 further including the step of measuring the nitrogen and phosphorus content of said pig manure prior to separating said waste water into a solids portion and liquid portion.

4. The method as defined in claim 3 wherein the ratio of nitrogen to P₂ O₅ is between 5 and 7.

5. The method of claim 1 wherein said liquid portion is mixed with said quarry fines without any pre-treatment.

6. The method of claim 1 wherein the step of separating said pig manure comprises the step of passing said liquid manure through an endless screw separator wherein the liquid pig manure is forced through a filter under a pressure.

7. The method of claim 1 wherein said step of separating said pig manure into a solids portion and liquid portion comprises the step of centrifuging said liquid pig manure.

8. The method of claim 1 wherein the step of separating said liquid from said quarry fines comprises the step of placing said quarry fines on a sloping surface.

9. The method of claim 2 wherein said treatment is carried out using mobile equipment at a farm producing said pig manure.
